(19) United States
(12) Patent Application Publication
(10) Pub. No.: US 2026/0228709 A1
(43) Pub. Date: Aug. 6, 2026

(54) Systems And Methods Using Electronic Wallet, Smart Digital Currency, And Biometric Data For Transactions

(71) Applicants: Fatai Quadri, Eputu (NG); Abiodun Asade, Cumberland, RI (US)

(72) Inventors: Fatai Quadri, Eputu (NG); Abiodun Asade, Cumberland, RI (US)

(21) Appl. No.: 19/149,616

(22) PCT Filed: Jan. 22, 2024
(86) PCT No.: PCT/US2024/012466

§ 371 Date: Jul. 21, 2025

Related U.S. Application Data
(60) Provisional application No. 63/440,257, filed on Jan. 20, 2023.

(51) Int. Cl. G06Q 20/06; G06Q 20/10; G06Q 20/36; G06Q 20/38; G06Q 20/40

(52) U.S. Cl. CPC G06Q 20/065; G06Q 20/102; G06Q 20/36; G06Q 20/381; G06Q 20/40145

(57) ABSTRACT

Systems and methods for executing purchase and sale transactions in digital virtual currency between buyers and sellers are provided. The systems and methods involve using digital biometric data, digital currency cards containing passwords; and digital bank information to verify the buyer and seller and ensure that the currency and the goods or services can be exchanged. A wireless communication network, for example, centralized computer server, is used for establishing communication between the buyer and seller.

### CROSS-REFERENCE TO RELATED APPLICATIONS

The application claims the benefit of U.S. Provisional Patent Application No. 63/440,257, filed Jan. 20, 2023, the entire disclosure of which is hereby incorporated by reference.

### BACKGROUND OF THE INVENTION

### Field of the Invention

The present invention relates generally to a comprehensive digital currency system and methods designed to integrate seamlessly with both emerging digital currencies and conventional financial transactions. It facilitates the efficient buying, selling, and exchange of Smart Digital Currencies (SDC) and Commercial Accounts (CA) across international borders through online channels and physical transactions using Smart Digital Currency Electronic Wallet (SDCEW) technology.

### Brief Review of the Related Art

In general, systems and methods for storing biometric data of individual persons are known. For example, the fingerprint, eye, and facial characteristics of a person may be stored. Computer processors may be used to store the biometric data of a person and then determine if the given biometric data of a particular user in the system matches the stored biometric data.

In recent years, cryptocurrencies such as Bitcoin (BTC) have become more popular. Bitcoin and other cryptocurrencies are decentralized and rely on a peer-to-peer network. The users can buy, sell, and exchange directly without a centralized system such as a bank or government. These cryptocurrencies are built on a distributed digital record transacted on a blockchain platform. There are linked bodies of data containing information about each transaction (for example, date, value, buyer and seller, and the like.) This information is accessible to all users on the network.

For example, U.S. Patent Application Publication US 2017/0024726 discloses an electronic wallet that may comprise a biometric authentication module for authenticating an owner of the electronic wallet. The owner may be authenticated by verifying authentication credentials received from the owner. The electronic wallet further comprises a scanner configured to scan one or more currency notes inserted or withdrawn for determine an amount of the one or more currency notes present in the electronic wallet. The electronic wallet also includes a wireless communication means for establishing a communication channel between the electronic wallet and a communication device.

U.S. Patent Application Publication US 2018/0232739 discloses a system having at least one processor that extracts biometric data from sensor data and compares the biometric data with stored biometric data for a first user. This biometric data is stored in a memory in communication with a processor. The processor may determine that the biometric data matches the stored biometric data based on this comparison. The processor may execute a transaction between the first user and a second user, the transaction comprising an exchange of digital currency between the users.

U.S. Patent Application Publication US 2018/0230506 discloses a system of validating a user's identity and available services through associated biometric features with the services. The services are verified through interfaces. The interface is able to read a variety of potential security parameters such as retina scanners, fingerprint readers, magnetic strips readers, and cameras. Different features of a user such as an index finger, ring finger, retina or the like are associated with the service via an interface.

U.S. Patent Application Publication US 2021/0389854 discloses biometric authentication, decentralized learning frameworks, and adaptive security protocols and services for a distributed operator terminals network. In some embodiments, the terminals may be hardware terminals, kiosks, or clients. In other embodiments, a security analysis may be performed, and security scores may be determined, for visitors requesting operations at terminals. A cloud network of points-of-sale, nodes, devices, or terminals may be provided. Each terminal may be capable of providing, interacting with, or transacting funds, such as fiat or cash, and virtual currency and cryptocurrency.

U.S. Patent Application Publication US 2022/0027866 discloses a digital virtual currency system that involves matching the digital virtual currency with a biometric authentication signal. The biometric signal is formed so that fingerprint authentication information matches with and is stored in each basic unit of a file of the virtual currency by a matching program. The sender's fingerprint authentication information may be converted into recipient's fingerprint authentication information by a blockchain-based digital virtual currency transaction guidance server. A sender terminal is configured to determine whether the file of the virtual currency matches the fingerprint authentication information. A blockchain-based digital virtual currency transaction guidance server determines whether there is a request for converting for the sender's fingerprint authentication.

There is a need for improved systems and methods for using biometric data to execute a transaction between a Buyer and Seller in digital currency. It would be desirable to have systems and methods that involve universal digital currencies based on the current hard physical currencies established on the current equivalent exchange rates, wherein the legal properties of physical money can be transferred into digital currency and converted to universal digital currencies based on the current exchange rate while the hard physical currencies will be taken out of circulation to avoid duplication. This system will create fairness in migrating hard physical money to digital currency by retaining the current accounting system in the buying and selling with principles of money been retained.

It also would be desirable to have a system and methods known as a platform that will guarantee the operation of trading with smart digital currency the following smart digital currency issuing central computer system (SDCICCS), Smart digital currency central computer system (SDCCCS), Smart digital currency central Bank (SDCCB), Smart digital currency electronic wallet (SDCEW), Smart digital currency Applications that can be installed on the mobile phone (SDCApp.) and Smart digital currency scanning machine (SDCSM), wherein the SDC can be activated through the dispensing device (SDCEW & SDCApp.). The present invention provides such systems and methods. Other advantages, features, and benefits of the present invention are described further below.

In one preferred embodiment, the present invention provides systems and methods for executing purchase and sale transactions in digital virtual currency between buyers and sellers. The systems and methods involve using digital biometric data, digital currency card containing passwords; and c) digital bank information to verify the buyer and seller and ensure that the currency and the goods or services can be exchanged. A wireless communication network, for example, centralized computer server, is used for establishing communication between the buyer and seller.

### SUMMARY OF THE INVENTION

The present invention provides a verification program for verifying an owner of the electronic wallet, wherein the owner is verified by matching: a) digital biometric information from the owner; b) a smart digital currency card containing a password from the owner; and c) digital bank information from the owner with a1) digital biometric information b1) a digital smart currency card containing a password; and c1) digital bank information stored by a centralized computer server that is in wireless communication with the electronic wallet. The electronic wallet system further comprises a wireless communication means for sending smart digital currency from the verified owner of the electronic wallet to a receiving second person using a wireless signal so that a transaction between the verified owner and second person can be completed.

In one embodiment, the verified owner of the wallet is a buyer of goods or services, and the second person is a seller of the goods or services. The digital biometric information from the verified owner may comprise characteristics selected from the group consisting of fingerprint, eye, facial characteristics, and combinations thereof. In one preferred embodiment, the smart digital currency is generated by converting physical currency (that is, paper money and coins) to the smart digital currency. In one embodiment, the smart digital currency card containing the password from the verified owner includes a six-digit identification number. The smart digital currency card may contain multiple passwords from the verified owner. The bank information from the verified owner may include information from a bank in the country of residence of the verified owner. In one embodiment, the electronic wallet system makes an automatic digital currency conversion so that a first currency from one country is converted to a second currency from another country. The verified owner of the electronic wallet and receiving second person can be located within different countries. In other instances, the verified owner of the electronic wallet and receiving second person can be located within the same country. Any suitable wireless communication means can be used. For example, wireless communication means can be selected from the group consisting of mobile phones, personal computers, laptops, and hand-held tablets. The digital bank information of the verified owner preferably includes digital bank account information. In one example, digital bank account information includes multiple bank account numbers.

The present invention also provides methods for making transactions. In one embodiment, the method comprises the steps of: i) providing a seller and buyer of goods or services, the seller and buyer being in wireless communication with each other; ii) verifying a seller of the goods or services, wherein the seller is verified by the seller sending digital information comprising: a) digital biometric information from the seller; b) a smart digital currency card containing a password from the seller; and c) digital bank information from the seller and this information is matched with digital information comprising a1) digital biometric information b1) a digital smart currency card containing a password; and c1) digital bank information stored by a centralized computer server; and verifying a buyer of the goods or services, wherein the buyer is verified by the buyer sending digital information comprising: a) digital biometric information from the buyer; b) a smart digital currency card containing a password from the buyer; and c) digital bank information from the buyer and this information is matched with digital information comprising a1) digital biometric information b1) a digital smart currency card containing a password; and c1) digital bank information stored by a centralized computer server; and sending smart digital currency from the verified buyer to the verified seller using a wireless communication signal so that a transaction between the verified buyer and seller can be made.

### BRIEF DESCRIPTION OF THE DRAWINGS

The novel features that are characteristic of the present invention are set forth in the appended claims. However, the preferred embodiments of the invention, together with further objects and attendant advantages, are best understood by reference to the following detailed description in connection with the accompanying drawings in which:

FIG. 1 is a schematic diagram showing a digital currency business model of the present invention;

FIG. 2 is a diagrammatic representation of how Smart digital currencies (SDC) are created in accordance with the present invention;

FIG. 3 is a schematic diagram showing SDC (100 Univ,) currencies that have been water-marked with 100 dollars meaning that the legal entity of the 100-dollar note has been transferred into the SDC 100UNIV based on an exchange rate in accordance with the present invention;

FIG. 4 is a flow chart showing an overview of Smart Digital Currency (SDC) operations and networks in accordance with the present invention;

FIG. 5 is a schematic diagram showing smart digital currency issuing central computer system (SDCICCS) features and operations in accordance with the present invention;

FIG. 6 is a flow chart for Application for opening Smart Digital Currency (SDC) account in accordance with the present invention;

FIG. 7 is a schematic diagram showing smart digital currency central computer system (SDCCCS) features and operation in accordance with the present invention;

FIG. 8 is a schematic diagram showing smart digital currency central bank (SDCCB) features and operation in accordance with the present invention;

FIG. 9 is a schematic diagram showing smart digital currency Electronic Wallet (SDCEW) features and operation in accordance with the present invention;

FIG. 10 is a schematic diagram showing smart digital currency Application downloaded and installed on mobile phone (SDCApp) features and operation in accordance with the present invention;

FIG. 11 is a schematic diagram showing smart digital currency Scanning machine (SDCSM) features and operation in accordance with the present invention;

FIG. 12 is a schematic diagram showing how the system of the present invention allows for account integration for users;

FIG. 13 is a schematic diagram showing how smart digital currencies share same attribute with physical money based on historical transformation;

FIG. 14 is a schematic diagram showing the SDC payment system;

FIG. 15 is a schematic diagram showing how physical currencies will transform into evolving smart digital currencies;

FIG. 16 is a schematic diagram showing an example of smart digital currency water marked with a 100 dollar note;

FIG. 17 is a schematic diagram showing that the accounts must be verified;

FIG. 18 is a schematic diagram showing how the Next of Kin will inherit the digital assets of the principal users on the system;

FIG. 19 is a schematic diagram showing how the systems and methods of this invention handle online shopping using the SDCEW or SDCApp;

FIG. 20 is a schematic diagram showing a transaction over Bluetooth when the buyer and seller are physically in contact;

FIG. 21 is a schematic diagram showing how the system and method of this invention can be used for the payment/sending/adding of money and this SDC money exists in different denominations just like having physical currencies in the wallet;

FIG. 22 is a schematic drawing showing how the system and method can be used for seeking change on-line;

FIG. 23 is a schematic drawing showing a Biometric account number for sending/receiving digital assets;

FIG. 24 is a diagram showing a Five hundred SDC UNIV;

FIG. 25 is a diagram showing a Two hundred SDC UNIV;

FIG. 26 is a diagram showing a One Thousand SDC UNIV;

FIG. 27 is a diagram showing a Five SDC UNIV; and

FIG. 28 is a diagram showing a a Ten SDC UNIV.

### DETAILED DESCRIPTION OF THE INVENTION

The present invention relates generally to Smart Digital Currency (SDC). By the term, “Smart Digital Currency”, it is meant currency that is issued digitally and electronically and is similar to paper and coin currency that is traditionally issued by the Central Bank of a given Country. In accordance with the present invention, the physical money legal properties (issued by World Bank and Central Bank of a given Country) will be transferred into the Smart Digital Currency by simply water marked on the smart digital currencies making it universal currencies. The invention, Smart Digital Currency Electronic Wallet also provide platform to house users different conventional financial accounts and financial cards within and across international borders, it also provides platform for biometric storage folder to house all biometric digital assets, Users can easily transfer their account to their next of kin that is already set up by the user in case of in capacitated situation.

The accounts on this invention cannot be used for any fraudulent activity based on the security associated with the set up. The security memory of each Smart Digital Currency can only be activated through the SDC electronic wallet and SDCApp. device of the present invention. This security protection will enable transaction information to be stored based on the currency location and identity of the owner. For example, an American citizen having Smart Digital Currency can use the currency to purchase a product from a Seller in Nigeria. In this instance, the initially stored information of the specific currency will be in SDCEW, SDCICCS, SDCCCS, and SDCCB on the mini central server that will be in each country while the main central server will be in America.

Once Smart Digital Currency has been used in a transaction as payment to a Seller in Nigeria, the same currency will have been currency security memory in the SDCEW, SDCICCS, SDCCCS and, SDCCB updated. This will trigger the money now stored in the SDC Nigeria Central to be updated. This will make it easy to track any digital currency and easy accounting. It will show that the Smart Digital Currency has migrated from the American citizen to a new owner in Nigeria.

The invention works exactly like physical currency (paper money and coins). For the world to adopt digital currency, it needs to share the same properties of tangible, physical currencies that have transformed over the ancient years (Representative and FIAT money). In accordance with the present invention, all physical currency (that is, paper money and coins) will be converted to representative digital money and the equivalent of this money will be determined using an intrinsic value of the dollar to calculate the equivalent. The transformation or conversion of the physical currency to smart digital currency can be done automatically using the systems and methods of the present invention, The history of money transformation will not be completed without adopting this invention, Money transforms from one form to another over the ages according to history “cowry shells in Africa, large stone wheels on the Pacific Island of Yap, and strings of beads called wampum used by Native Americans and early American settlers”. The transformation of money through ages give birth to what is more convenient based on the properties, however Smart Digital Currency is created to follow the trend of money transformation and retain the same properties as Money is a store value, Money is a unit of account and money is medium of exchange.

Each digital currency will have legal properties of physical money there by sustaining on each country's total volume of physical cash. The SDCCB of each Country will have the right to scan the physical currencies while the legal properties of this physical currencies will be transferred to SDC by each country SDCICCS. This means there will be no single currency with the same number. Each digital currency will inherit its legal properties from already controlled physical currencies. In one preferred embodiment, the electronic wallet system can automatically make digital currency.

This currency will be issued to the owner through a validated other conventional bank account into their SDC electronic wallet and SDCApp (accessible online.) The SDC wallet and SDCApp can be installed on a mobile phone device which will use special algorithms to manage currency storage memory for transactions, other conventional financial accounts/financial cards, biometric data, releasing of currency as exchange into another electronic wallet, releasing change of biometric data as ownership changes, and allowing to source for change in case the owner does not have the required denomination to make the transaction.

The systems and methods of the present invention have many advantageous features. In general, the systems and methods can perform the following types of transactions within the borders of a country or across country borders: a) the payment/receipt of Smart Digital Currencies (SDC) into a User SDC Account; b) the payment/receipt of other financial currencies based on a user's commercial account (CA), wherein the electronic wallet can store different denominations like a traditional physical wallet that stores physical denominations; c) the payment/receipt of other financial currencies into a financial account or card, which allows a user to manage a range of financial accounts/cards, particularly from one financial account/card to multiple financial accounts/card, wherein the financial accounts/cards are open within one country or multiple countries. The financial accounts can be used within the borders of a single country or across the borders of multiple countries); d) storing and sending/receiving digital assets in accordance with verified biometric accounts.

In another embodiment, the method involves the steps of: 1) registration on the portal with the user's biometric data or a one-time password; 2) validating a a conventional bank account (single or multiple accounts that can be on cards), wherein the user can convert his/her conventional currencies into Smart Digital Currency (SDC); 3) buying goods or services with payment in Smart Digital Currency (SDC) or a conventional Commercial Account (CA) that has been verified; 4) making payment in accordance with verified biometric accounts; and 5) making payment using conventional Commercial Accounts.

In yet another embodiment, the system and methods of the present invention involve an authentication system for verifying an owner of the electronic wallet, wherein the owner is authenticated and verified by matching digital biometric information such as fingerprints, eye and facial characteristics from the owner. The smart digital currency is: a) representation of a smart digital currency such as, but not limited to, an image of the Smart Digital Currency containing specific numbering and markings identifying it as digital currency b) a smart digital currency card. The digital bank account information is electronically stored from the owner's banks and communicates with the electronic wallet through electronic means via an electronic connection to the owner's bank.

The following terms are used in the Examples:
SDC (Smart Digital Currency);
SDC-ICCS (Issuing centralized computer system);
SDC-CCS (centralized computer system);
SDC-CB (central bank);
SDS-SM (scanning machine);
SDC-APP (application); and
SDC-N (network).

Different embodiments of the systems and methods of the present invention are illustrated by the following Examples, but these Examples should not be construed as limiting the scope of the invention.

### Example 1

In this Example, the smart digital currency (SDC) electronic wallet and smart digital currency apps (SDCApps) of the present invention can be installed on a mobile phone.

### Example 2

In this Example, the systems and methods of the present invention can be used for digital transformation, particularly from physical currencies to evolving digital currencies.

### Example 3

In this Example, the physical currencies can be transferred their legal entity into the evolving smart digital currencies in accordance with the present invention, since the World recognizes every country has legal tender, and this will make it easier for the World to accept evolving smart digital currencies more easily.

### Example 4

In this Example, the systems and methods of this invention have safeguards so they cannot be used for fraudulent activities.

### Example 5

In this Example, the systems and methods of this invention have Next of Kin programs so the the Next of Kin will inherit the digital assets of the principal users in cases when the user is incapacitated due to any reason.

### Example 6

In this Example, a customer in Nigeria wants to buy a shirt. The customer using his/her electronic wallet device will search for an online shop to buy the shirt. In this instance, he/she sees the shirt in a Ferrari store in London. Then, he/she will click the purchase option on the electronic wallet device. He/she will enter the Seller's account number (always like SDCV_{FQ}-Ng-0000001, assuming the customer is the same customer who was the first to apply for a SDC account in Nigeria) and enter the purchase amount. This transaction will be transmitted via the SDC network as encode genetic Z_{JO} assuming the buyer name is accurate and the SDCCCS processes the transaction once confirmed sufficient SDC fund, SDCCCS will transmit the amount to the Seller as genetic Y_{JO} to SDCEW by showing on is view. Once the Seller accepts the payment, a biometric confirmation will prompt on the Buyer's electronic wallet. Once the Buyer has confirmed his biometric information on the electronic wallet, the payment will be deducted from the Buyer's electronic wallet in the correct denomination amount. The transfer will be made to the Seller's electronic wallet and there will be a view on the Seller's electronic wallet to confirm the Seller's biometric upload. Once the Seller confirms the biometric information, the currency will be displayed in the Seller's electronic wallet. Then, another message will be sent to the Buyer to release the currency to the Seller. Once this transaction is completed, the currency will be automatically loaded in the Seller's electronic wallet with the Seller's biometric data.

There can be different embodiments of the above-described purchase and sale transaction including, for example, the following scenarios:
1) Physical Contact—If the Buyer is physically present in the Seller's shop, the transaction can occur over a Bluetooth device. A person can release their smart digital currencies or CA currencies from their online account on the SDCCCS and deposit it into their Electronic Wallet vault. If a person loses their electronic digital device, it is like losing money in their real physical wallet. The lost digital currency cannot be recovered until the person recovers their Electronic Wallet. The beauty of the present invention is that no other person can use the Electronic Wallet. Only the true owner of the Electronic Wallet can use the Wallet because it is synchronized with the personal biometric data of the Owner.

### Example 7

If the Buyer is physically present in the Seller's shop and both buyer and seller are having SDCEW, the buyer will release SDC into his SDCEW vault (Released currencies mean currencies that can be transact over Bluetooth) the buyer and seller over Bluetooth will initiate this transaction without the aid of internet. The service will not be available to a customer using the SDCApp on their phone. In FIG. 21, schematic diagram showing how the system and method of this invention can be used for the payment/sending/adding of money and this SDC money exists in different denomination just like having physical currencies in the wallet.

### Example 8

2) Long Distances—This Example shows that if the Buyer and Seller are physically far apart, the transaction can take place over the Internet.

3) Upfront Payment by Sincere Buyers—In the event that the Buyer pays the digital currency upfront before the items are delivered by courier, the Buyer will not make a final release of the funds (change of ownership) until the items are delivered, and the Buyer accepts the items. Once this delivery and acceptance is confirmed, the Buyer will then release the funds (change of ownership). In this way, any possible fraudulent activity by the Seller (for example, non-delivery of a product or delivery of a low-quality product) can be prevented.

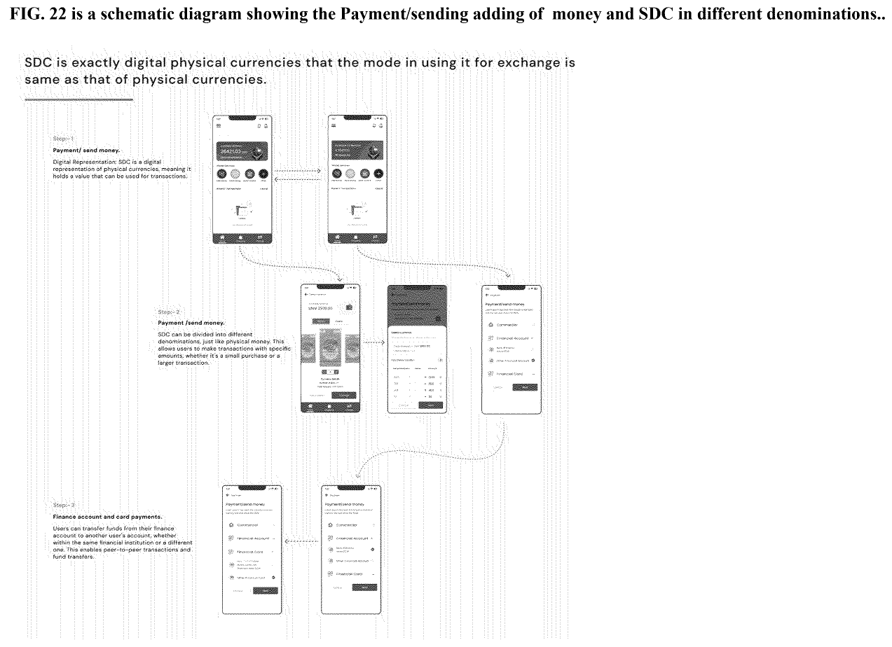

4) Upfront Payment by Insincere Buyers—In the event that the Buyer pays the digital currency upfront before the items are delivered by courier, the Buyer will not do the final release of the currency (Change of Ownership) until the Buyer receives and accepts the items. In case the Buyer does not accept the items or refuses to release the digital currency to the Seller, then the currency will be suspended until a Digital Arbitration Court determines who is at fault (Buyer or Seller). Both the Buyer and Seller will not be able to use such currency for any other transaction. The currency will show in both of their Electronic Wallets as being an uncompleted transaction. This suspension of the digital currency protects both the Buyer and Seller in any transaction. In FIG. 22, a schematic drawing showing how the system and method can be used for seeking change on-line is provided.

### Example 9

5) No correct denomination—Seek change through the Online Bank—In a case where a Buyer has 2,000 UNIV in his Electronic Wallet and he/she wants to buy a shirt that only costs 265.34 UNIV, the Buyer will need to apply for online change. He or she can exchange his 2,000 UNIV denomination to another lower denomination once the Buyer clicks on “Change” on his/her electronic wallet. Then, he or she will access the Online Bank and ask for the denomination of change that he or she wants. Once this change is selected and provided in the correct value, the Electronic Wallet will automatically, via the biometric data, release the 2,000 UNIV and replace it with the selected denomination in the Electronic Wallet. Later, the Buyer can decide to seek for a change in this denomination. Examples of different denominations are provided below:
1,500UNIV,200UNIV,100UNIV, 100UNI,50, UNIV,10UNIV,20,
UNIV,10UNIV,5UNIV, 4UNIV, UNIVF9, UNIVF8,
UNIVF7, UNIVF6, UNIVF5, UNIVF4, UNIVF3, UNIVF2, UNIVF1.

These denominations will allow the Buyer to pay with 200UNIV, 100UNIV, 50UNIV,10UNIV and UNIVF10 (3 pcs) and UNIVF4.

6) No correct denomination-Seek change through the Seller—A Buyer might seek change through the Seller. For example, a Buyer has 2,000 UNIV digital currency in his/her Electronic Wallet, and he/she wants to buy a shirt costing only h 265.34 UNIV. The same procedure for this transaction as described above under Section 5) will take place. The Seller will take the 2,000 UNIV currency from the Buyer's Electronic Wallet, and the Seller will click on a refund change button. This will automatically select the right denomination of the currency for the change and send it back to the Buyer who will now receive it. Both the Buyer and Seller will have to release the ownership of the currency in this exchange. The Buyer will release the 2,000 UNIV for purchasing the shirt, while the Seller will release the correct amount of change in digital currency.

### Example 10

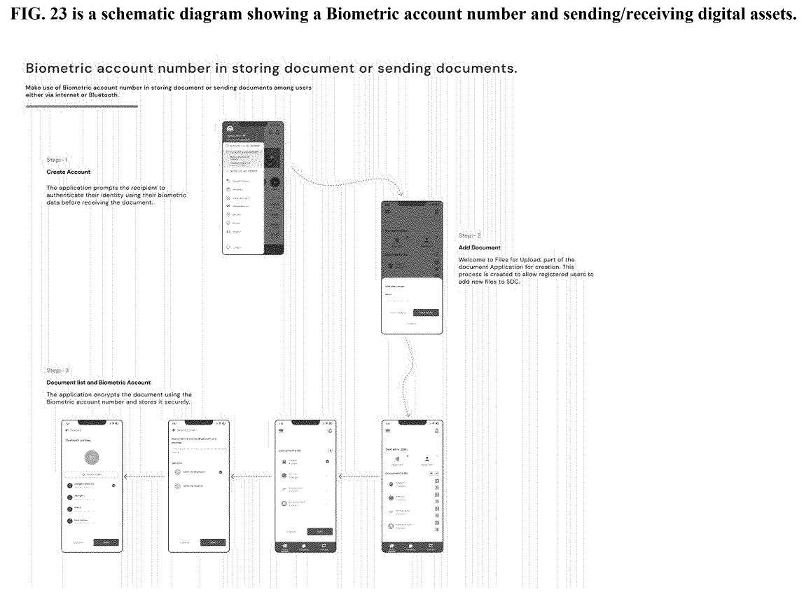

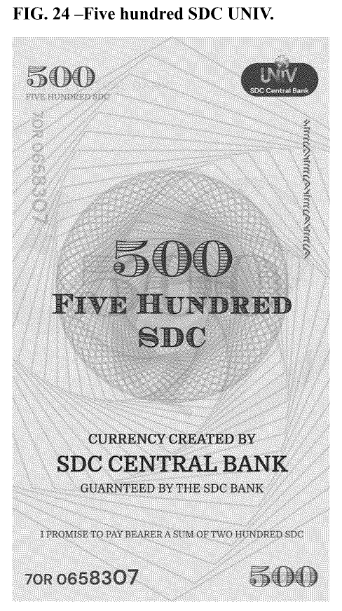

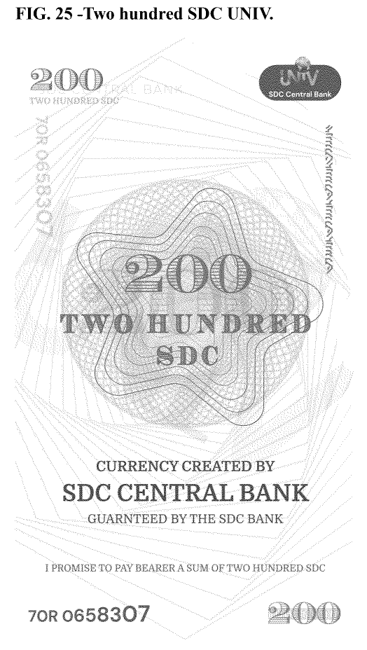

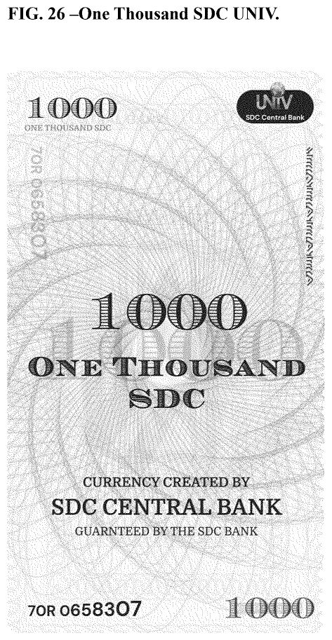

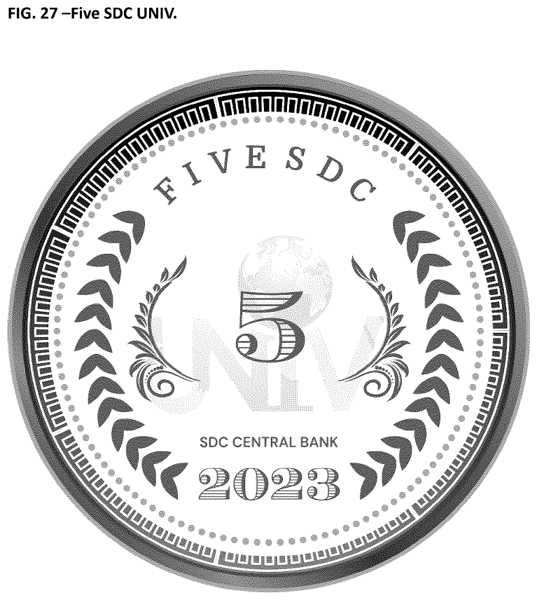

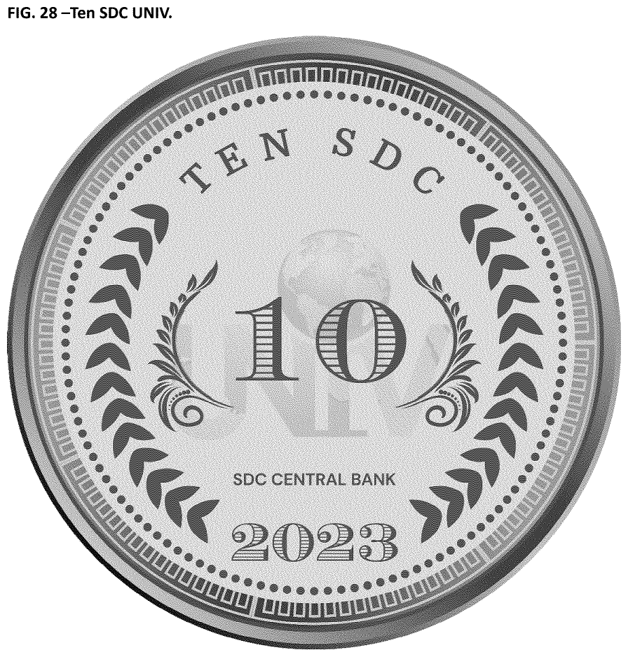

This Example shows a system and method with a Biometric account number for sending/receiving and storing digital assets. This system and method uses encoded biometric information to send or receive digital assets and digital asset can also be view on the platform via the biometrics of the user. In FIG. 23, a schematic drawings showing a Biometric account number for sending/receiving digital assets is shown. In FIGS. 24-28, different UNIVs are shown.

There are many features, advantages, and other benefits of the system of the present invention including the following:
a) Each digital currency will inherit is legal properties from the scanned physical money or currencies as it already exists in each country.
b) The SDC central bank of each country will have the right to scan the physical money in each of their Country.
c) There will be whole and fraction denominations. This means there will be no single currency with same inheritance legal properties of physical money or currencies since all the currencies are already regulated and controlled by the world bank and central bank of each Country.

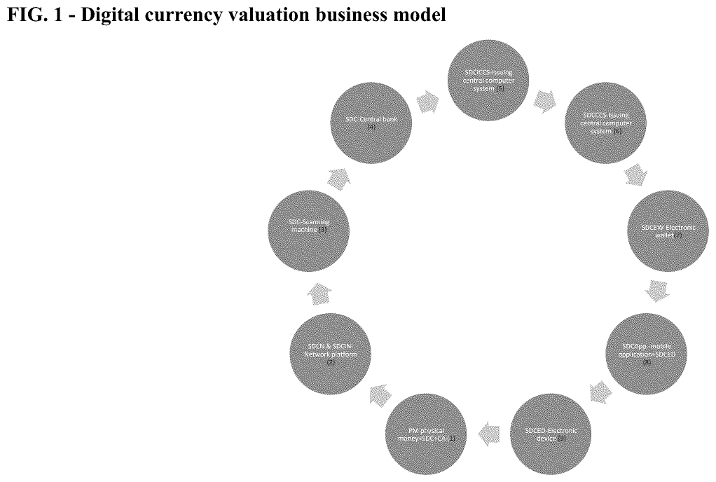

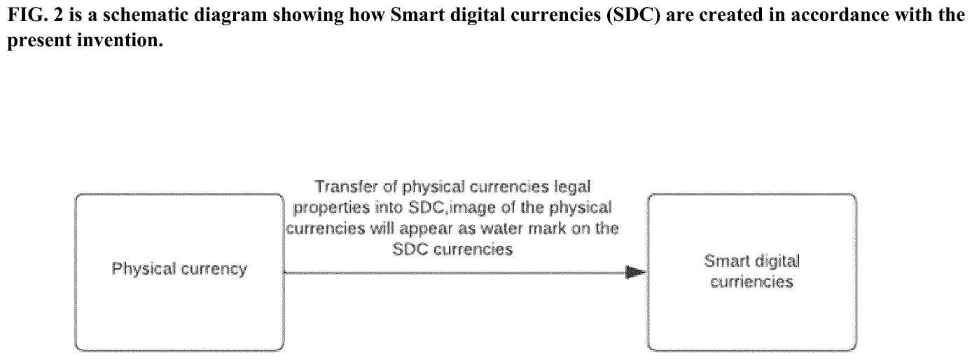

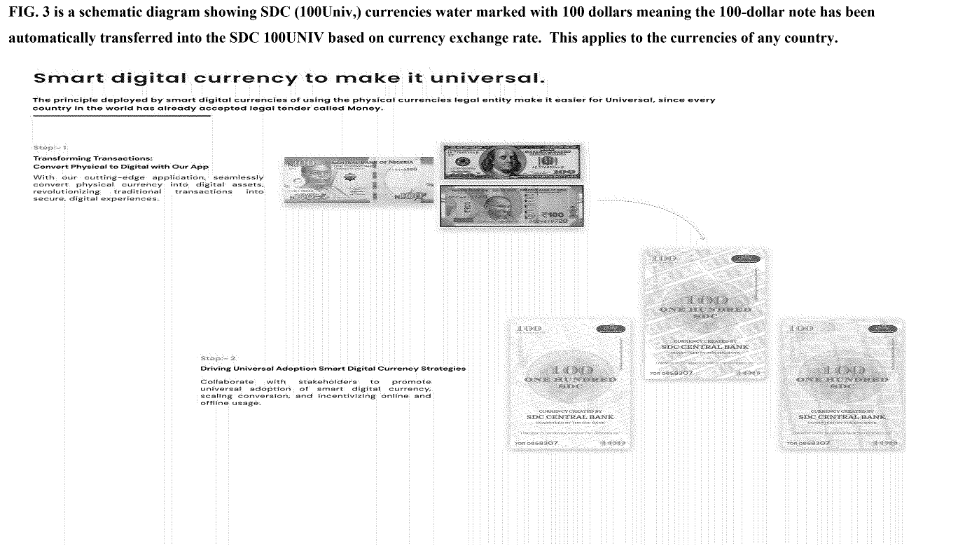

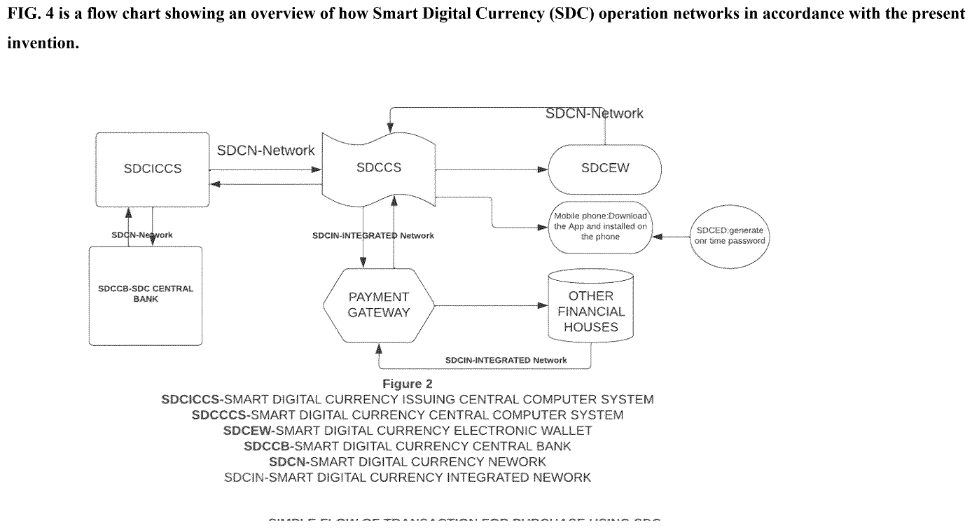

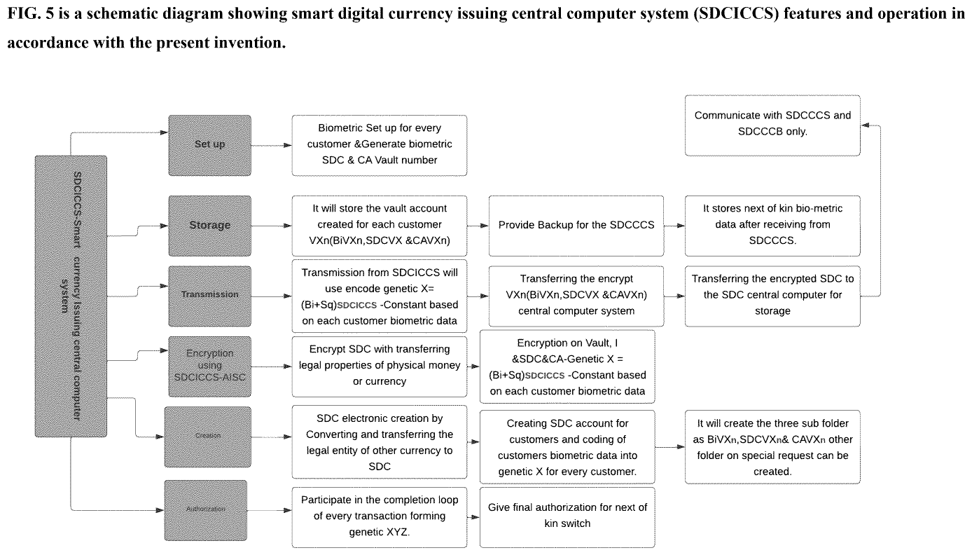

In the following Examples, reference is made to the following Figures. FIG. 1, a schematic diagram showing a digital currency business model is shown. In FIG. 2, a schematic diagram showing how Smart Digital Currencies are created in shown. In FIG. 3, a schematic diagram showing SDC (100 Univ,) currencies that have been water-marked with 100 dollars meaning that the legal entity of the 100-dollar note has been transferred into the SDC 100UNIV based on an exchange rate. In FIG. 4, a flow chart showing an overview of Smart Digital Currency (SDC) networks and operations is shown. In FIG. 5, the features and operations of a smart digital currency issuing central computer system (SDCICCS) in accordance with the present invention is shown.

Application Specific Integrated Chip (ASIC)—This chip allows for managing currencies (SDC and Conventional money such as credit cards and money in the bank) located in the two vaults (SDC vault and CA Vault), encrypt currency with Owner's biometric data for release or acceptance, store transactions, register transactions on SDC network (SDCN) and SDC integrated network (SDCIN).

Dual Function Accounting—The EW has dual functions for SDC and commercial accounting (conventional accounting systems).

Internet and BlueTooth—The EW can use Internet or SDC network for its operation. The EW can also operate using BlueTooth.

Vault System—The EW uses a Smart Digital Currency (SDC) and Commercial Account (CA).

Switch Mode—The EW uses a switch mode for transactions over the Internet SDC, and BlueTooth.

Biometric Activation Key—The EW uses a biometric activation key.

Camera—The EW uses a camera that can rotate or take a selfie photo.

Entering bank account and credit card numbers—The EW can use a Commercial Account (CA) having features that allow a person to enter their normal commercial accounts and load their credit cards from one (1) to infinity.

Operation of Electronic Wallet (EW)—The SDC integrated network will seek permission from the various account and card operators to load the CA vault with the Owner's permission. Once the approval is granted, the money will drop into the Owner's CA vault and, via the CA vault account and the SDC integrated account, the Owner can spend this money.

Entering SDC Number—In case the EW Owner wants to pay a Seller with SDC, the Owner will enter the Customer's SDC vault account number and this transaction will take place over the SDC network as described above. Multiple accounts can be entered to make payments to different EW Owners.

Activating the Next of Kin Key—The EW has a Next of Kin Hidden Vault-Owner. in case the Owner of the EW wants his or her next of kin to have access to his or her EW, the Owner will press the next of kin activation key. Then, a dialogue box will prompt asking how many next of kin, In case the Owner states there are three people, the biometric data and name of each of the three persons will be collected. (For example, the fingers can be scanned three times and the face four times.) Once this biometric information is collected, the Owner will click the acceptance key. Then, this biometric data will be automatically stored in the EW under Next-of-Kin vault. The ASIC will automatically update the SDN and SDCN.

Operational Switch to Next of Kin—The Next of Kin switch will only be activated when it is proven that the Owner of the Electronic Wallet is deceased. Sufficient evidence will need to be provided. The SDCN will activate the switch over button. This will deactivate the Owner's Biometric Data and allow the next of kin Biometric Data to be activated.

Biometric Activation—When a customer places an order for his or her Electronic Wallet (EW), the customer will submit his or her biometric data and photograph. The company will load this data into the Electronic Wallet stored in the ASIC. The Electronic Wallet will not be activated until the Owner receives a press biometric activation key. This will prompt the Owner to scan his ten fingers each one three times and also scan his face four times along a shape using selfie mode. Once all of this information matches the pre biometric data loaded from the factory, the activation code will trigger automatically, and the two vaults will change color from red to green. This means that the Electronic Wallet is ready to receive currency into SDC. Then, the various accounts and cards under the commercial accounts will be entered.

On-Line Shopping—This feature allows a person to download online shops that can be accessed for transactions in case there is no network, and him or her is in SDC. The Electronic Wallet comes with special algorithms that encrypt currency loaded into the Wallet with the Owner's biometric data. The SDC for the On-Line shop will still be based on the principles of physical currency.

Negotiation View—The Electronic Wallet will have a Negotiation View that allows the Buyer and Seller to negotiate a price once the price is entered.

Price Acceptance Key—The Electronic Wallet has a price acceptance and decline key that works both ways. Once the Buyer enters the price and press acceptance key, it will generate a dialogue box to the Seller to accept the entered price. Once this price is accepted by the Seller, it will trigger a payment view. In the case that the Seller declines the price, it will return to negotiation view,

Payment View—The Electronic Wallet has a payment view that allows a person to enter the Seller's payment account number. In case the Buyer is paying via SDC, the Buyer enters the Electronic Wallet account of the Seller. In case, the Buyer is making payment via a commercial account, the Buyer will enter the Seller's Commercial Account (CA) vault account number. This will enable the Buyer to pay through their regular Commercial Account (CA) view and allow the Buyer to enter the Seller's payment account number. The Buyer can pay through their regular Commercial Account (CA) directly from their bank account or credits cards. This is done by selecting card or Commercial Account (CA) on payment view.

Option of Payment Under Commercial Account (CA) Vault—There can be a transaction with no Internet and SCDIN either from the Seller or Buyer or both. (When this happens, the transaction can only take place in person or through physical through Bluetooth.) Also, there can be an On-Line transaction meaning that there is Internet, SDCN, and SDCIN for both Buyers and Sellers.

Battery Power—The Electronic Wallet can be battery-powered. The battery power can be used for loading and updating information on the ASIC, and to update the SDCN and SDCIN in the event there is not network. For example, there may only be local transactions when On-Line shopping is unavailable. The battery power also can be used for BlueTooth transactions.

SDCICCS=This comprises of hardware and a program, the system is in our head office hope to be USA, Hardware like any other electronic and special software which enable to perform the following operation:
Biometric Set up for every customer
Generate biometric SDC Vault number
Generate biometric CA Vault number
SDC electronic creation
Encrypt SDC with transferring legal properties of physical money or currency
Transferring the generated SDC & CA Vault number to the SDC central computer system
Transferring the encrypted SDC to the SDC central computer for storage

SDCICCS Specific chip—every message by particular customer will be transmitted using the customer biometric numeric sequence for examples Biometric set up of customer “n” in the SDCICCS will generate a genetic X (Biometric numeric sequence for customer “n”), this customer “n” will have is biometric set up in the SDC central computer system, SDCCCS specific chip will generate a genetic Y (Biometric numeric sequence for customer “n” (Bin), program in the SDCCCS will combine Xₙ to form the genetic Yₙ, The program on the SDCEW on receiving transmission for the same customers n will combine the following Xₙ+Yₙ+Biₙ to form genetic Z but in the case of downloaded App on the mobile phone it will only have the following combination before the transaction can be completed Xₙ+Yₙ+SDCED (SDC electronic device that do generate one time password)

Xₙ will always be the same for specific customer for examples customer “n” with name like John Paul will always be X_{JP}, another customer with a name like Nanna Okon will always be X_{NO} etc.

Y genetic will always change in a sequence for every transaction for example customer “n”, will have Yₙₜ with “t” as subset sequence that will always change in every transaction

Z genetic will always change in a sequence for every transaction for example customer “n”, will have Zₙₜ with “t” as subset sequence that will always change in every transaction

Create Vault for each customer as soon as the Biometric is set up to generate the genetic Xₙ, symbolize as VXₙ (Vault Biometric numeric sequence for customer “n”)

It will create the three sub folder as BiVXₙ, SDCVXₙ& CAVXₙ other folder on special request can be created.

Encryption on Vault, I &SDC&CA-Genetic X=(bi+Sq)_{SDCICCS}—Constant based on each customer biometric data

Transmission from SDCICCS will use encode genetic X=(Bi+Sq)_{SDCICCS}—Constant based on each customer biometric data

Transfer the customers Vault to the SDCCCS while it keeps back up.

Creating SDC account for customers and coding of customers biometric data into genetic X for every customer.

Converting and transferring the legal entity of other currency to SDC

Provide Backup for the SDCCCS

Participate in the completion loop of every transaction forming genetic PMYZ.

Transferring converted currency to SDCCB

Communicate with SDCCCS and SDCCCB only.

It stores next of kin biometric data after receiving from SDCCCS.

Give final authorization for next of kin switch

### Application for SDC Account Opening—Start Up

FIG. 4 is a flow chart showing an overview of Smart Digital Currency (SDC) operations and features with the following features and operations.

Assumed customer “n” wants to open SDC account by applying for hardware SDCEW or download the SDC app to be used with his or her mobile phone number will visit the SDCN SDC-network to fill the form and load their biometric (Bi).

The customer “n” will fill the form with his or her required information and his or her biometric information via his or her mobile phone or go to the designated center to applied.

Once the form is submitted by customer “n” and system confirmed all data provided and biometric data submitted meet up the required resolution, the form will sent to the SDCICCS for processing.

The SDCICCS-AISC will use the customer “n” saved biometric data on the SDCN to create a binary code between 0 & 1 using sequence of combination to form genetic PM for “n” customer.

SDCICCS-AISC will further use the binary code between 0&1 (Sequence of combination) genetic Xn this will be used to encrypt a folder created called Vault (V) created for customer “n” designated as VXn, country tag of the customer “n” and account number shall be attached, designated as VXn-Country tag-00000001.

For example, a customer from Nigeria can apply for a SDC account opening with SDCEW and since the customer is the first from Nigeria, the SDCICCS-AISC will create an account for the customer as VXFQ-Ng0000001, and the account will be saved on the SDCICCS.

SDCICCS-AISC will create three sub account folders for the customer “n” as Bin-Ng0000001, SDC VXFQ-Ng0000001 and CA VPMFQ-Ng0000001 this will be saved inside the main folder VXFQ-Ng0000001

Bi(FQ)n-Ng0000001—Folder will be used to store customer “n” Biometric data

SDC VXFQ-Ng0000001—Used to store SDC and information about SDC transaction

CA VXFQ-Ng0000001—Used to store other finance house transaction (CA) and information about CA transaction

The Account Number will be created for the customer from Nigeria.

VXYZ (Customer initial)n—Country tag-000000D—Main account for customer “n” on the SDCEW

BiXY(Customer initial)n—Country tag-000000D—Folder will be used to store customer “n” Biometric data stored on the SDCEW

SDC VXYZ(Customer initial)n—Country tag-000000D—Used to store SDC and information about SDC transaction on the SDCEW

CA VXYZ(Customer initial)n Country tag-000000D—Used to store other finance house transaction (CA) and information about CA transaction on the SDCEW

VXY (Customer initial)n—Country tag-000000D—Main account that the downloaded App on mobile phone will always access for customer “n” transaction

SDCED—will always be used to complete the transaction on the Appl installed on the mobile phone for customer “n”

SDC VX(Customer initial)n—Country tag-000000D—this is the account the downloaded App on mobile phone will always access for customer “n” transaction

CA VXY(Customer initial)n Country tag-000000D—this is the account the downloaded App on mobile phone will always access for customer “n” transaction

i-Represent the subset sequence of genetic Y and Z in every transaction, for example, the customer from Nigeria may have an account number VXFQ-Ng0000001 on SDCICCS, VXYFQ-Ng0000001 on SDCCCS, VXYZFQ-Ng0000001 on the SDCEW, for every transaction VXFQ-Ng0000001 this will remain constant while these two accounts will have subset, I as indicated which needs to match for transaction to be completed VXYFQi-Ng0000001 on SDCCCS, VXYZFQi-Ng0000001 on the SDCEW

SDCCCS—This comprises of hardware and a program, the system is in our head office hope to be USA, Hardware like any other electronic and special software which enable to perform the following operation.

FIG. 5 is a schematic diagram showing smart digital currency issuing central computer system (SDCCCS) with the following features and operations.

Store all customers SDC & CA Vault numbers

Transaction between SDC customers

Transaction to other commercial accounts through gateway to other finance houses

Process customer request for SDC to the SDCICCS

Every customer has a Vault on the SDCCCS (for example customer “n”has vault genetic XYn—to be symbolized as VXYn which will contain customer “n”, Biometric information, SDC & CA Vault Number, Amount of SDC, Amount of CA, transaction details, next of kin details,

It communicates with the SDCEW and App downloaded installed on the mobile phone

It also communicates to other financial houses through available gateway

Manage every transaction of the customers through SDCIN and SDCN

Provide primary backup of all customers transaction.

It received next of kin biometric data from the SDCEW and through the APP installed on the mobile phone and store it along with the main customer biometric.

Transmit received next of kin biometric to SDCICCS.

Receive customers application to open SDC account online via the SDCN (Smart Digital Currency Network).

Participate in the completion loop of every transaction forming genetic XYZ.

Perform Biometric coding of account created forming genetic Y

Received generated genetic Xn (SDCVXn & CA VXn) Vault number

SDCCCS specific chip will generate a genetic Y (Biometric numeric sequence for customer Y) using the biometric information on the SDCCCS and received genetic Xn to form combination of XY vault

Provide Backup for the SDCEW

Participate in the completion loop of every transaction forming genetic PMYZ.

Transferring converted currency to SDCEW

Communicate with SDCEW and other financial houses.

It stores next of kin biometric data after receiving from SDCCCS.

Give second line approval for next of kin switch

VXY (Customer initial)n—Country tag-000000D—Main account for customer “n” on the SDCCCS

BiX(Customer initial)n—Country tag-000000D—Folder will be used to store customer “n” Biometric data stored on the SDCCCS

SDC VXY(Customer initial)n—Country tag-000000D—Used to store SDC and information about SDC transaction on the SDCCCS

CA VXY(Customer initial)n Country tag-000000D—Used to store other finance house transaction (CA) and information about CA transaction on the SDCCCS

Encryption on Vault, I &SDC&CA-Genetic Y=(X+Bi+Sq)SDCCCS—Constant based on each customer biometric data

Transmission from SDCCCS will use encode Y=(X+Bi+Sq)t—This will always varies for each transaction because “t” represent subset sequence that will be generated each transaction based customer biometric data

### Smart Digital Currencies Central Banks

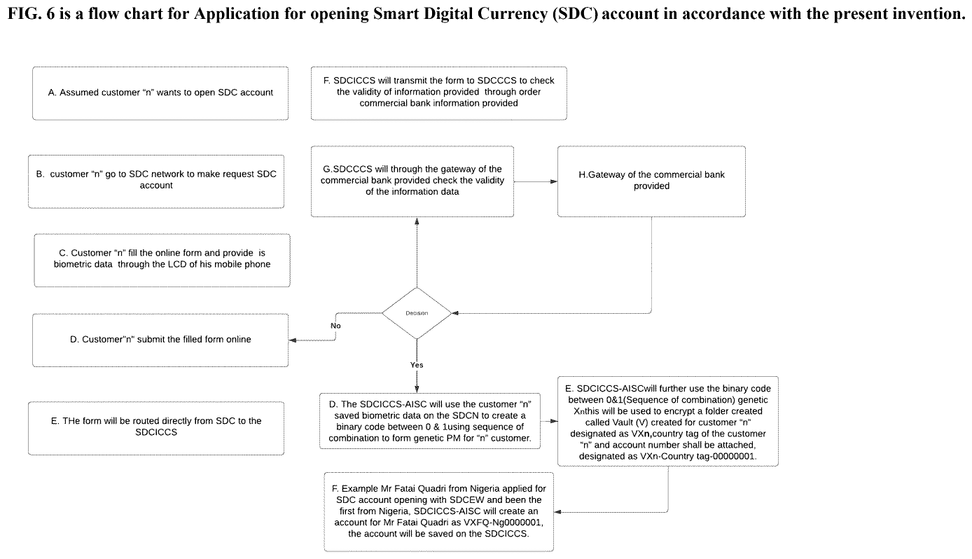

FIG. 6 is a flow chart showing an Application for opening a Smart Digital Currency (SDC) account with the following features and operations.

SDCCB=Smart digital currencies central banks are server that will host all scanned physical currencies and the record of where all the scanned physical monies are kept. It will be an establishment that will be integrated with the commercial bank in each country as to control the physical money or currencies for safe keep or will be migrated to the country central bank for safe keep or controlled.

Once a customer has his or account number created and activated based on the device for dispensing SDCEW or SDCApp, the customer will be eligible to convert his or her physical currencies based on the number of physical currencies he or she desired to convert.

The customer makes the request through his or her dispensing device for example customer Mr Tom is banking with a commercial bank in Nigeria called Zenith bank and he wants to convert 150,000 Naira of his physical money to SDC, Mr Tom on his dispensing device will click on converting physical money to SDC, a dialogue box will open asking him to enter bank details which is Zenith bank, once the customer enter correct bank details, this message will be transmitted via SDCN to the SDCCCS and SDCCCS will through the gateway contact the Mr Tom bank (Zenith bank) for approval, once the approval is granted, SDCCCS will notified the Mr Tom through his dispensing device and notified the SDCICCS, this will transmit message to the SDCCCB for the approval and scanning of the physical money or currencies of 150,000 naira at the Zenith bank with Swift code, IBAN, if SDCCB has arrangement with the Zenith bank of Nigeria, it means they will have SDC scanning machine, this machine will scanned the 150,000 naira physical money or currencies with security code of the bank, the scanned physical money with the bank security code will the transmitted to the SDCCB server, keeping the record that Mr Tom of Zenith bank has scanned 150,000 Naira and the physical money is in custody of the Zenith bank with specific bank details, SDCCCB will transmit the scanned 150,000 Naira to the SDCICCS, this system will now processed the received scanned currencies into SDC in the proper equivalent physical money based on conversion to American US dollars, each of the currencies will have the legal entities of the scanned 150,000 Naira, Processed currencies which is now an SDC will be stored into his folder under SDCVX vault, transmitted to SDCCCS and stored under his vault as SDCXY and transmitted to SDCEW and stored as SDCXY Now Mr Tom has SDC of equivalent to his 150,000 Naira in his Vault available for transaction

### Smart Digital Electronic Wallet

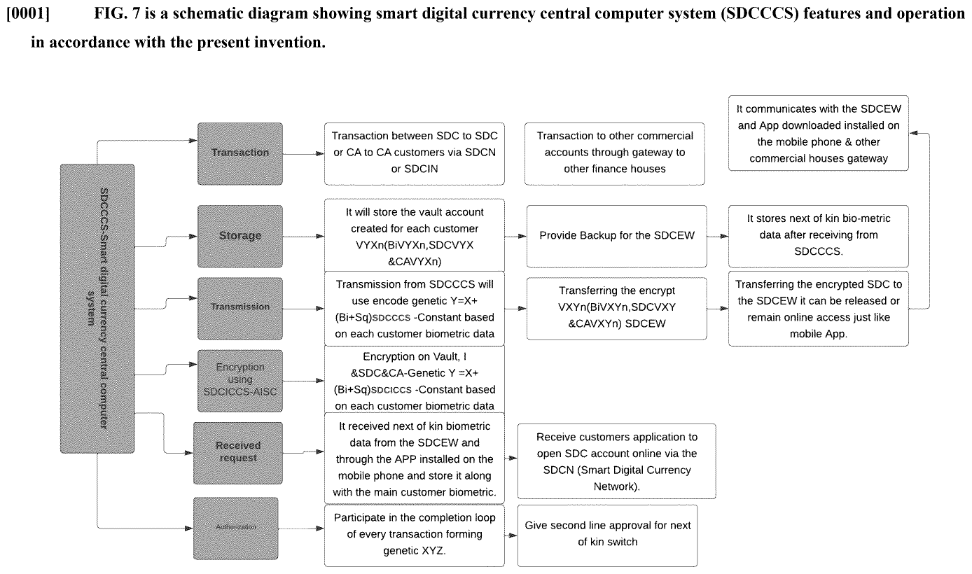

FIG. 7 is a schematic diagram showing a smart digital currency central computer system (SDCCCS) with the following features and operations.

SDCEW=This is an electronic gadget that will be issued to SDC customer it comprises of hardware and a program, special software which enable to perform the following operation

Received communication via internet from SDCCCS

It stored Owners Biometric data transmitted from SDCCCS inside the created folder

It has application specific integrated chips which enable in to perform genetic Z operation

Received created owner account number vault and stored on the device

The received vault (VXYn-comprises of sub folder Bin, SDCVXYn & CAXYn) will be further processed using the ASIC on the device to encode the Vault as (VXYZn—comprises of sub folder Bin, SDCVXYZn & CAXYZn)

Encryption on Vault, I &SDC&CA-Genetic Z=(Y+Bi+Sq)SDCEW—Constant based on each customer biometric data

Transmission from SDCEW will use encode Z=(Y+Bi+Sq)t—This will always varies for each transaction because “t” represent subset sequence that will be generated each transaction based customer biometric data

It has inbuilt camera

It has LCD screen that will be used to do owner biometric activation and sending next of kin biometric data

It has Wi-Fi and Bluetooth

It has button for biometric activation

It has button for switch mode of transaction depending on the SDC or CA

The LCD can also be searched for online shop to do buying and selling

It can do transaction over Bluetooth with customer that are in physical contact for currencies that has already be dropped into the Vault on the SDCEW

VXYZ (Customer initial)n—Country tag-000000D—Main account for customer “n” on the SDCEW

BiXY(Customer initial)n—Country tag-000000D—Folder will be used to store customer “n” Biometric data stored on the SDCEW

SDC VXYZ(Customer initial)n—Country tag-000000D—Used to store SDC and information about SDC transaction on the SDCEW

CA VXYZ(Customer initial)n Country tag-000000D—Used to store other finance house transaction (CA) and information about CA transaction on the SDCEW

### SDCApp-Smart Digital Currency Application

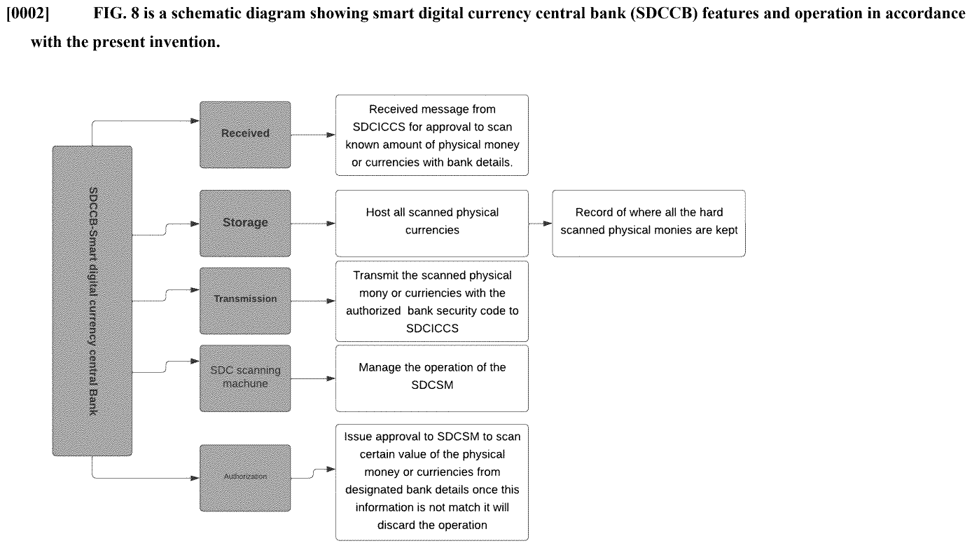

FIG. 8 is a schematic diagram showing smart digital currency central bank (SDCCB) features and operations.

SDCApp=Smart digital application which is available on the SDC network for customer who do not want SDCEW but intend to use their existing phone for the SDc operation, will after application for SDC account the, once the account is created the customer will be prompt to download and installed the Application and necessary biometric confirmation will be activated, once activation is successful the customer will be sent SDC electronic device, upon receival the customer will still do biometric activation before it can be used on the mobile phone for one time password generation

Received communication via internet from SDCCCS

It works with Owners Biometric data online on the SDCCCS inside the created folder

It does not have application specific integrated chips, so it works with activated SDC electronic device which enable it to perform complete transaction

The App managed created owner account number vault online.

The online vault (VXYn—comprises of sub folder Bin, SDCVXYn & CAXYn) will be further processed using the SDC electronic device by generating one time password to complete the transaction.

Features of the mobile phone like Camera, LCD, WFI etc will work with the App,

It has LCD screen that will be used to do owner biometric activation and sending next of kin biometric data

The SDC App has dialogue box for biometric activation

The SDC App has dialogue box for switch mode of transaction depending on the SDC or CA

The LCD can also be searched for online shop to do buying and selling

It cannot do transaction over Bluetooth with customer that are in physical contact for currencies

VXY (Customer initial)n—Country tag-000000D—Main account that the downloaded App on mobile phone will always access for customer “n” transaction

SDCED—will always be used to complete the transaction on the Appl installed on the mobile phone for customer “n”

SDC VX(Customer initial)n-Country tag-000000D-this is the account the downloaded App on mobile phone will always access for customer “n” transaction

CA VXY(Customer initial)n Country tag-000000D-this is the account the downloaded App on mobile phone will always access for customer “n” transaction

### SDCSM—Smart Digital Currencies Scanning Machine

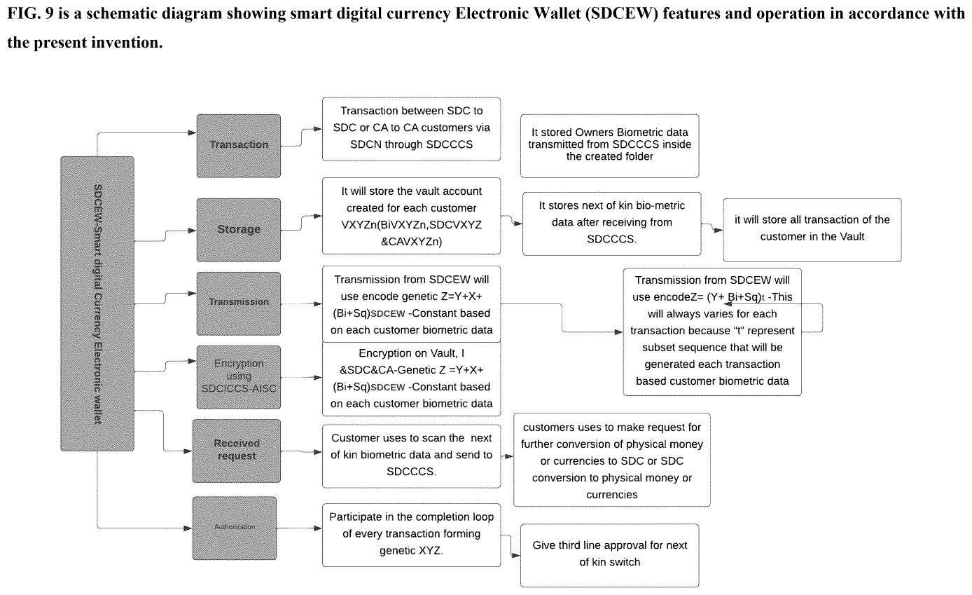

FIG. 9 is a schematic diagram showing smart digital currency Electronic Wallet (SDCEW) features and operations.

This machine will have some special security number and it will placed in any commercial bank that SDCCB has an integrated arrangement to warehouse the converted physical money or currencies' in Different part of the world.

All scanned physical money or currencies will be taken out of circulation to avoid duplication of same money or currencies, normally it will have be destroyed since the legal entities already transferred into SDC but in the advent where customers also need to convert the SDC back to the physical money or currencies this is why the need to keep the scanned physical money or currencies.

Any SDC converted to physical money or currencies will also automatically be withdrawn from circulation because the legal entity will be deactivated.

### Features of the SDCSM

It can scan and process one million notes in less than 20 seconds

It is a multiple users one machine can be use by minimum of ten operators at the same time.

It performs activation process on the scanned money or currencies once the money scanned and transmitted to the SDCCB,

it will require the activation by the physical money or currencies to guarantee that it secured in accordance with the approved system that will ensure no duplication of same money or currencies in circulation.

### Example 11

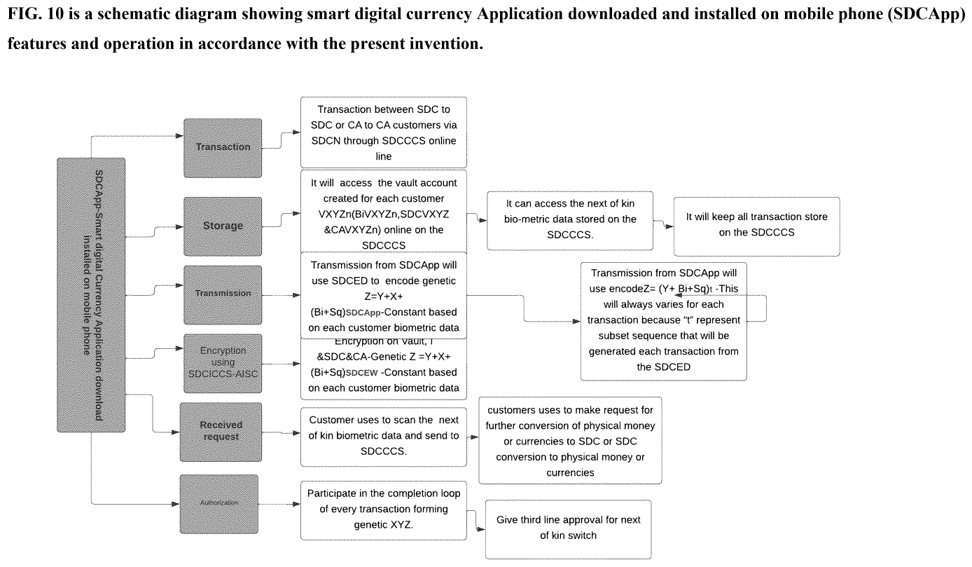

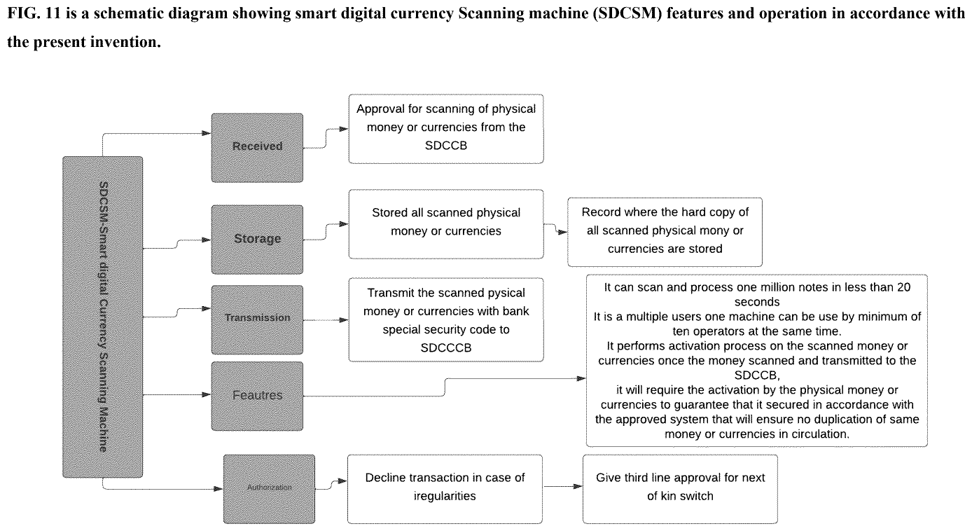

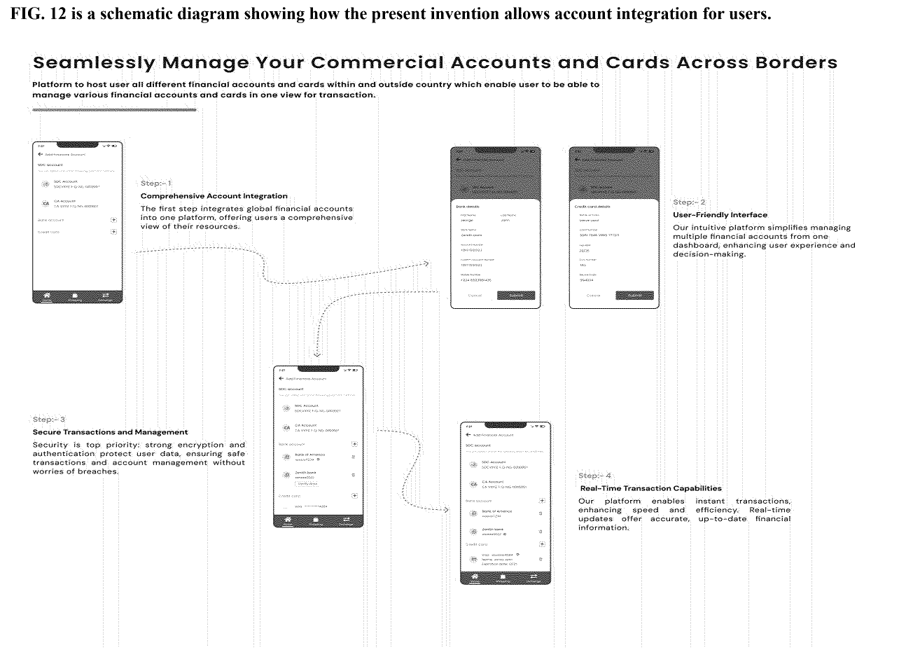

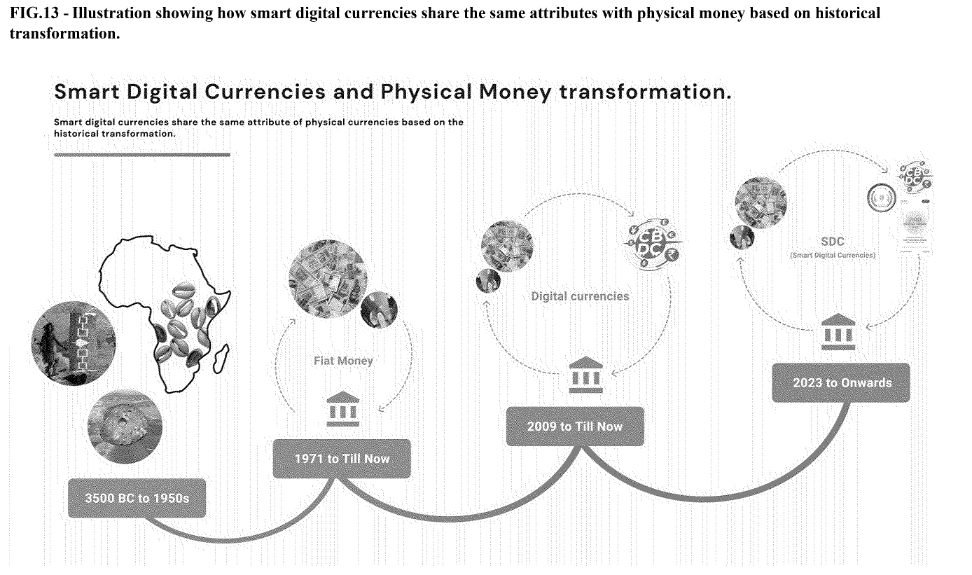

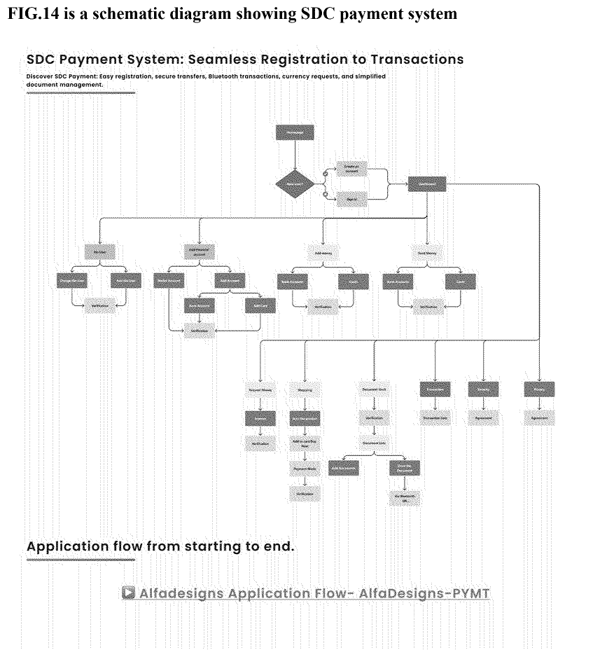

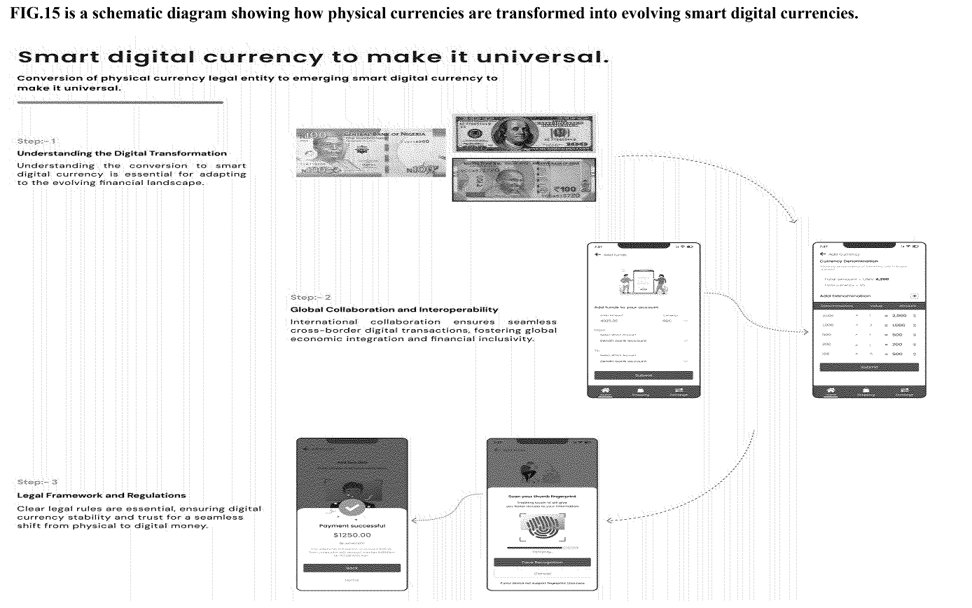

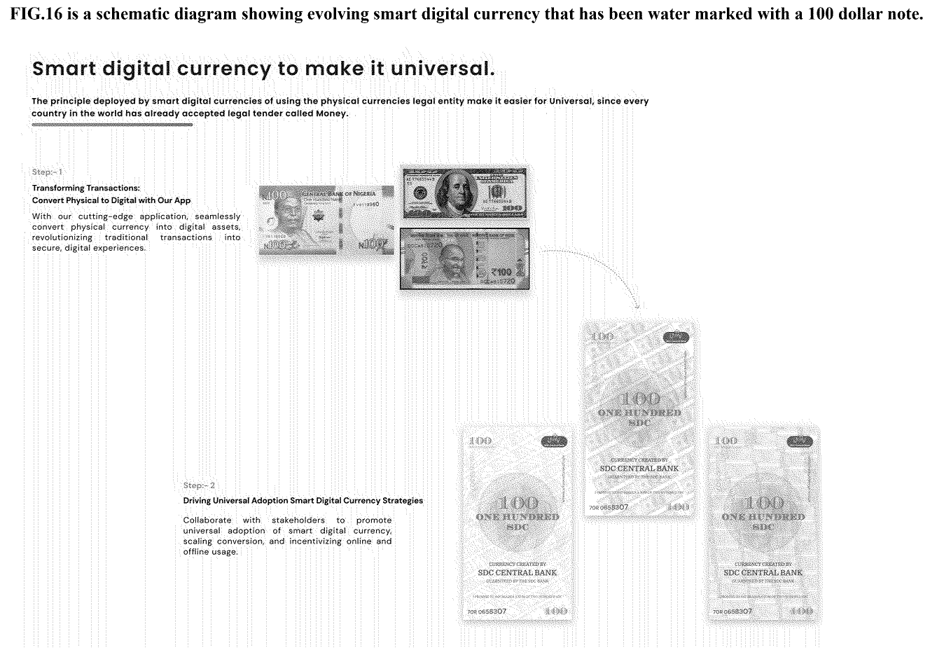

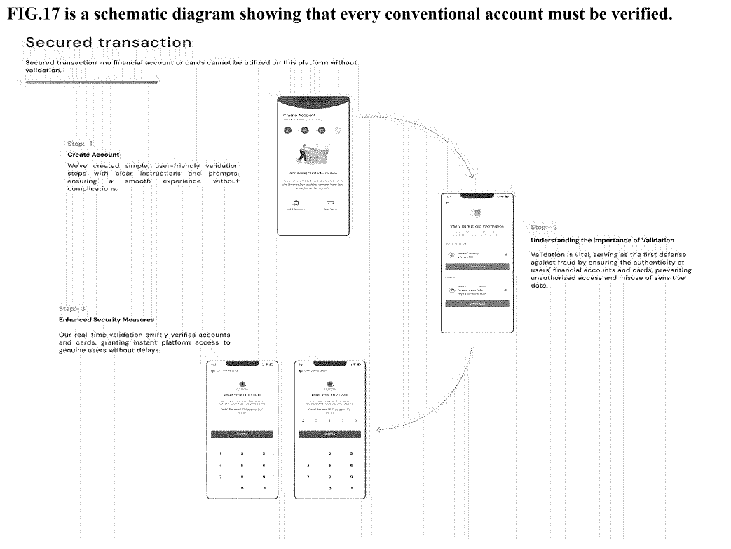

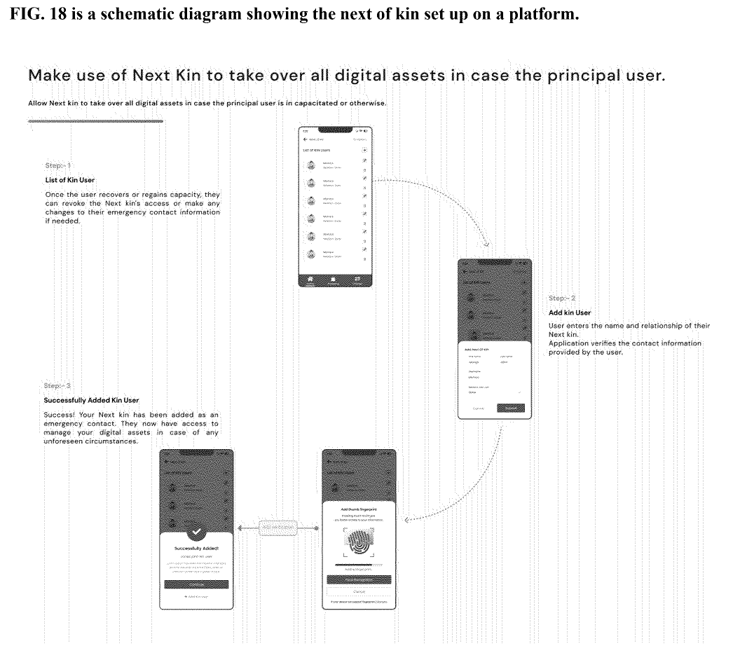

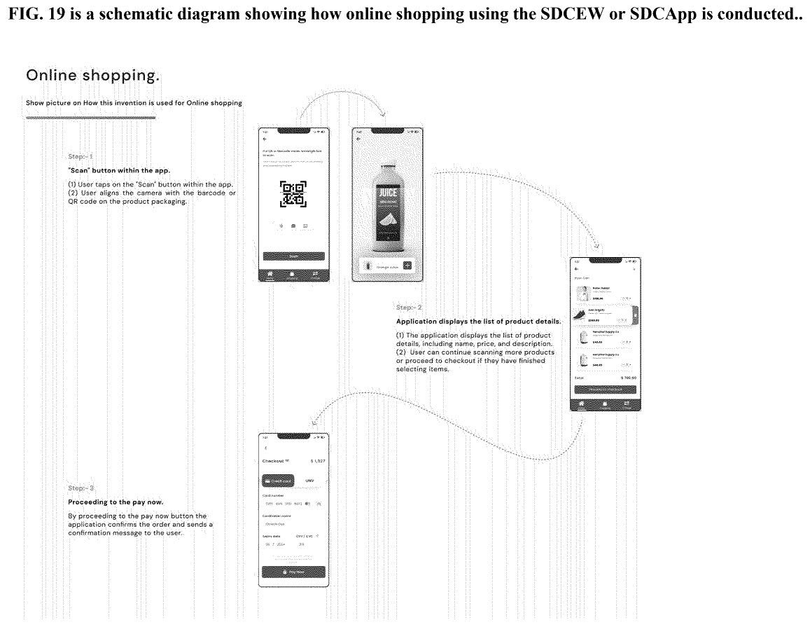

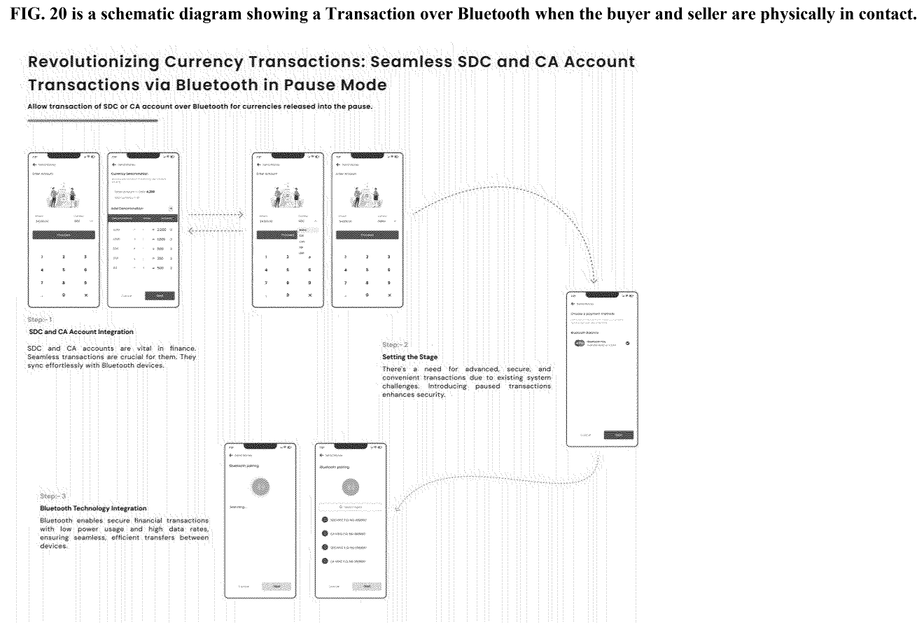

In this Example, if the Electronic Wallet (EW) Owner loads 20,000 UNIV and other money from his or her Commercial Account (CA). For example, the Owner can load $6,500 and all their credit cards worth $100,000. If the Owner wants only $10,000 to be transferred from his CA Vault, the dialog box will ask the Owner how the money should be removed from his account and credits cards. Based on the Owner's instructions, the money will be requested through the SDCIN. Once permission granted, the money will be transferred. This Electronic Wallet (EW) system and other EW systems are shown in the Figures. Methods for making transactions in accordance with the present invention are also shown in the Figures. In particular, reference is made to the following Figures: FIG. 10 is a schematic diagram showing smart digital currency Application downloaded and installed on mobile phone (SDCApp) features and operation in accordance with the present invention. FIG. 11 is a schematic diagram showing smart digital currency Scanning machine (SDCSM) features and operation in accordance with the present invention. FIG. 12 is a schematic diagram showing how the system of the present invention allows for account integration for users. FIG. 13 is a schematic diagram showing how smart digital currencies share the same attributes with physical money based on historical transformation. FIG. 14 is a schematic diagram showing the SDC payment system. FIG. 15 is a schematic diagram showing how physical currencies will transform into evolving smart digital currencies. FIG. 16 is a schematic diagram showing an example of smart digital currency water marked with a 100 dollar note. FIG. 17 is a schematic diagram showing that the accounts must be verified. FIG. 18 is a schematic diagram showing how the Next of Kin will inherit the digital assets of the principal users on the system. FIG. 19 is a schematic diagram showing how the systems and methods of this invention handle online shopping using the SDCEW or SDCApp. FIG. 20 is a schematic diagram showing a transaction over Bluetooth when the buyer and seller are physically in contact.

We claim:

1. An electronic wallet system, comprising:
a verification program for verifying an owner of the electronic wallet, wherein the owner is verified by matching: a) digital biometric information from the owner; b) a smart digital currency card containing a password from the owner; and c) digital bank information from the owner with a1) digital biometric information b1) a digital smart currency card containing a password; and c1) digital bank information stored by a centralized computer server that is in wireless communication with the electronic wallet;
a wireless communication means for sending smart digital currency from the verified owner of the electronic wallet to a receiving second person using a wireless signal so that a transaction between the verified owner and second person can be completed.

2. The electronic wallet system of claim 1, wherein the verified owner of the wallet is a buyer of goods or services, and the second person is a seller of the goods or services.

3. The electronic wallet system of claim 1, wherein the digital biometric information from the verified owner comprises characteristics selected from the group consisting of fingerprint, eye, facial characteristics, and combinations thereof.

4. The electronic wallet system of claim 1, wherein physical currency is converted to smart digital currency.

5. The electronic wallet system of claim 1, wherein the smart digital currency card contains multiple passwords from the verified owner.

6. The electronic wallet system of claim 1, wherein the bank information from the verified owner includes information from a bank in a country of residence of the verified owner.

7. The electronic wallet system of claim 1, wherein the electronic wallet system makes an automatic digital currency conversion so that a first currency from one country is converted to a second currency from another country.

8. The electronic wallet system of claim 1, wherein the verified owner of the electronic wallet and receiving second person are located within the same country.

9. The electronic wallet system of claim 1, wherein the verified owner of the electronic wallet and receiving second person are located within different countries.

10. The electronic wallet system of claim 1, wherein the wireless communication means is selected from the group consisting of mobile phones, personal computers, laptops, and hand-held tablets.

11. The electronic wallet system of claim 1, wherein the digital bank information of the verified owner includes digital bank account information.

12. The electronic wallet system of claim 11, wherein the digital bank account information includes multiple bank account numbers.

13. A method of making a transaction, comprising the steps of:
providing a seller and buyer of goods or services, the seller and buyer being in wireless communication with each other;
verifying a seller of the goods or services, wherein the seller is verified by the seller sending digital information comprising: a) digital biometric information from the seller; b) a smart digital currency card containing a password from the seller; and c) digital bank information from the seller and this information is matched with digital information comprising a1) digital biometric information b1) a digital smart currency card containing a password; and c1) digital bank information stored by a centralized computer server;
verifying a buyer of the goods or services, wherein the buyer is verified by the buyer sending digital information comprising: a) digital biometric information from the buyer; b) a smart digital currency card containing a password from the buyer; and c) digital bank information from the buyer and this information is matched with digital information comprising a1) digital biometric information b1) a digital smart currency card containing a password; and c1) digital bank information stored by a centralized computer server;
sending smart digital currency from the verified buyer to the verified seller using a wireless communication signal so that a transaction between the verified buyer and seller can be made.

14. The method of claim 13, wherein the seller and buyer are located within the same country

15. The method of claim 13, wherein the seller and buyer are located within different countries.

16. The method of claim 13, wherein the digital biometric information from the seller and buyer comprises characteristics selected from the group consisting of fingerprint, eye, facial characteristics, and combinations thereof.

17. The method of claim 13, wherein the smart digital currency cards of the seller and buyer contains passwords.

18. The method of claim 13, wherein physical currency is converted to smart digital currency.

19. The method of claim 13, wherein the transaction between the verified buyer and seller includes making an automatic digital currency conversion, wherein a first currency from one country is converted to a second currency from another country.

20. The method of claim 13, wherein the wireless communication means is selected from the group consisting of mobile phones, personal computers, laptops, and hand-held tablets.
